(19) United States
(12) Patent Application Publication
(10) Pub. No.: US 2021/0102426 A1
(43) Pub. Date: Apr. 8, 2021

(54) DAYLIGHTING DEVICE

(71) Applicant: Sharp Kabushiki Kaisha

(72) Inventors: SHUMPEI NISHINAKA, Sakai City (JP); TORU KANNO, Sakai City (JP); HIDEOMI YUI, Sakai City (JP); DAISUKE SHINOZAKI, Sakai City (JP); SHUN UEKI, Sakai City (JP); TSUYOSHI KAMADA, Sakai City (JP)

(21) Appl. No.: 16/322,765

(22) PCT Filed: Aug. 4, 2017
(86) PCT No.: PCT/JP2017/028406

§ 371 Date: Feb. 1, 2019

(30) Foreign Application Priority Data
Aug. 5, 2016 (JP) 2016-154855

(51) Int. Cl. E06B 9/24; F21S 11/00; G02B 5/02

(52) U.S. Cl. CPC E06B 9/24; F21S 11/002; E06B 2009/2494; E06B 2009/2417; G02B 5/0278

(57) ABSTRACT

The present invention, in an aspect thereof, is directed to a daylighting device including: a daylighting sheet including: a transparent base member; and a plurality of transparent daylighting sections on a first face of the base member; and at least one hollow structural body composed of a resin provided on a second face of the base member opposite the first face, the at least one hollow structural body including: a transparent, first plate section; a transparent, second plate section opposing the first plate section; a plurality of structural bodies extending in a direction of alignment of the daylighting sections between the first plate section and the second plate section and arranged at prescribed intervals in a direction of extension of the daylighting sections; and hollow portions between the structural bodies.

### TECHNICAL FIELD

The present invention, in an aspect thereof, relates to daylighting devices.

The present application claims priority to Japanese Patent Application, Tokugan, No. 2016-154855, filed on Aug. 5, 2016, the entire contents of which are incorporated herein by reference.

### BACKGROUND ART

Daylighting devices equipped with a daylighting film are well known and often installed over one of faces of a window pane in order to efficiently guide sunlight or other outdoor light that hits the window pane into the room or building (see, for example, Patent Literature 1).

### CITATION LIST

### Patent Literature

Patent Literature 1: Japanese Unexamined Patent Application Publication, Tokukai, No. 2013-156554

### SUMMARY OF INVENTION

### Technical Problem

Such daylighting devices may disadvantageously warp due to thermal contraction of the daylighting film.

In a daylighting device with a daylighting film, it is important for the light-receiving face of the daylighting film to remain flat to achieve good daylighting effects over time. The daylighting device could warp, for example, under the weight of the base member to which the daylighting film is attached and under the stress that occurs when the daylighting film is attached to the base member. This issue has been addressed so far by, for example, using base members that are made of glass or thick resin material.

This solution, however, adds to the weight of the daylighting device, which in turn requires, for example, a bulky and cumbersome structure and extra cost to attach the daylighting device to the window.

The present invention, in one aspect thereof, has been made in view of these problems of conventional art. An object of the aspect of the invention is to provide a daylighting device that allows for less warping and that comes with less weight.

### Solution to Problem

The present invention, in one aspect thereof, is directed to a daylighting device including: a daylighting sheet including: a transparent base member; and a plurality of transparent daylighting sections on a first face of the base member; and at least one hollow structural body composed of a resin provided on a second face of the base member opposite the first face, the at least one hollow structural body including: a transparent, first plate section; a transparent, second plate section opposing the first plate section; a plurality of structural bodies extending in a direction of alignment of the daylighting sections between the first plate section and the second plate section and arranged at prescribed intervals in a direction of extension of the daylighting sections; and hollow portions between the structural bodies.

In the daylighting device in accordance with the aspect of the present invention, the structural bodies may be transparent.

In the daylighting device in accordance with the aspect of the present invention, the at least one hollow structural body may be configured such that the hollow portions are continuous in the direction of alignment of the daylighting sections.

In the daylighting device in accordance with the aspect of the present invention, the structural bodies may be subjected to high-visible-light-reflection processing.

In the daylighting device in accordance with the aspect of the present invention, at least some of the structural bodies may be inclined by a prescribed angle with respect to the second face of the base member.

In the daylighting device in accordance with the aspect of the present invention, the structural bodies may have a thickness that changes in a direction perpendicular to the second face of the base member.

In the daylighting device in accordance with the aspect of the present invention, the at least one hollow structural body may include: a first wall section that covers either a light-receiving face of the daylighting sheet on which there is formed a fine structure or a back face of the daylighting sheet opposite the light-receiving face; and a second wall section opposing the first wall section with the structural bodies intervening between the first and second wall sections, and at least one of the structural bodies, the first wall section, and the second wall section may be subjected to micro-scattering processing.

In the daylighting device in accordance with the aspect of the present invention, the scattering processing to which at least one of the structural bodies, the first wall section, and the second wall section is subjected may be anisotropic of light-diffusion direction in such a manner as to impart high diffusivity in the direction of extension of the daylighting sections.

In the daylighting device in accordance with the aspect of the present invention, the at least one hollow structural body may include t o hollow structural bodies disposed opposing each other, and the daylighting sheet may be disposed between the two hollow structural bodies.

The daylighting device in accordance with the aspect of the present invention may further include: a protection sheet that covers one of surfaces of the daylighting sheet; and a protection member on at least two of at least four top, bottom, left, and right sides of the protection sheet, the protection member being capable of simultaneously holding the daylighting sheet and the at least one hollow structural body.

In the daylighting device in accordance with the aspect of the present invention, the at least one hollow structural body may include a plurality of hollow structural bodies, and the hollow structural bodies may be coupled by a coupling section.

In the daylighting device in accordance with the aspect of the present invention, the coupling section may be formed integrally with the hollow structural bodies.

In the daylighting device in accordance with the aspect of the present invention, the coupling section may be light-blocking.

### Advantageous Effects of Invention

The present invention, in an aspect thereof, can provide a daylighting device that allows for less warping and that comes with less weight.

### BRIEF DESCRIPTION OF DRAWINGS

FIG. 1 is a perspective view of an overall structure of a daylighting device in accordance with a first embodiment.

FIG. 2A is a cross-sectional view of the overall structure of the daylighting device in accordance with the first embodiment.

FIG. 2B is an enlarged cross-sectional view of a part of the daylighting device shown in FIG. 2A.

FIG. 2C shows a variation example of daylighting sections.

FIG. 3 is a cross-sectional view of a structure of a hollow structural body.

FIG. 4 is a diagram representing a relationship between the thickness and stiffness of a flat acrylic plate used as a resin plate.

FIG. 5 is a diagram that shows a comparison of a relationship between the thickness and weight of a flat glass plate with that of a flat acrylic plate.

FIG. 6 is a diagram representing a relationship between the thickness and weight of a hollow structural body (hollow polycarbonate sheet).

FIG. 7 is a schematic illustration of a room model where a daylighting device is installed.

FIG. 8 is a cross-sectional view of daylighting sections of a daylighting device.

FIG. 9 is a cross-sectional view, taken parallel to the X-Y plane, of a daylighting sheet and a hollow structural body, showing optical paths of light passing through them.

FIG. 10A shows a structure of Example 1 of the daylighting device in accordance with the first embodiment.

FIG. 10B shows an additional installation example of a daylighting device in accordance with Example 1.

FIG. 11 shows a structure of Example 2 of the daylighting device in accordance with the first embodiment.

FIG. 12A shows a variation example of a daylighting device.

FIG. 12B shows a variation example of a daylighting device.

FIG. 12C shows a variation example of a daylighting device.

FIG. 13A shows a structure of Example 3 of the daylighting device in accordance with the first embodiment.

FIG. 13B shows a variation example of a daylighting device of Example 3.

FIG. 14 is a cross-sectional view, taken parallel to the X-Y plane, of a structure of a daylighting device in accordance with a second embodiment.

FIG. 15 is a cross-sectional view, taken parallel to the X-Y plane, of a structure of Example 1 of the daylighting device in accordance with a third embodiment.

FIG. 16 is a cross-sectional view, taken parallel to the X-Y plane, of a structure of Example 2 of the daylighting device in accordance with the third embodiment.

FIG. 17 is a cross-sectional view, taken parallel to the X-Y plane, of a structure of Example 3 of the daylighting device accordance with the third embodiment.

FIG. 18 is a cross-sectional view, taken parallel to the X-Y plane, of a structure of Example 4 of the daylighting device in accordance with the third embodiment.

FIG. 19 is a cross-sectional view, taken parallel to the X-Y plane, of a structure of daylighting device in accordance with a fourth embodiment.

FIG. 20 is a cross-sectional view, taken parallel to the X-Y plane, of one of ribs in a hollow structural body in accordance with the fourth embodiment.

FIG. 21 is a cross-sectional view, taken parallel to the X-Y plane, of a structure of a major part (shape of a rib) of a hollow structural body of Example 1 of the fourth embodiment.

FIG. 22 is a cross-sectional view, taken parallel to the X-Y plane, of a structure of a major part (shape of a rib) of a hollow structural body of Example 2 of the fourth embodiment.

FIG. 23 is a cross-sectional view, taken parallel to the X-Y plane, of a structure of a major part (shape of a rib) of a hollow structural body of Example 3 of the fourth embodiment.

FIG. 24 is a cross-sectional view, taken parallel to the X-Y plane, of a structure of a daylighting device in accordance with a fifth embodiment.

FIG. 25 is a cross-sectional view, taken parallel to the X-Y plane, of a structure of a daylighting device in accordance with a sixth embodiment.

FIG. 26 is a cross-sectional view, taken parallel to the X-Y plane, of a structure of a daylighting device in accordance with a seventh embodiment.

FIG. 27 is a cross-sectional view, taken parallel to the X-Y plane, of a structure of Example 1 of the daylighting device in accordance with the seventh embodiment.

FIG. 28 is a schematic cross-sectional view, taken parallel to the X-Y plane, of a structure of a daylighting device in accordance with an eighth embodiment.

FIG. 29 is a cross-sectional view, taken parallel to the X-Y plane, of a structure of Example 1 of the daylighting device in accordance with the eighth embodiment.

FIG. 30 is a cross-sectional view, taken parallel to the X-Y plane, of a structure of Example 2 of the daylighting device in accordance with the eighth embodiment.

FIG. 31 is a cross-sectional view, taken parallel to the X-Y plane, of a variation example of Example 2 of the daylighting device in accordance with the eighth embodiment.

FIG. 32 is a cross-sectional view, taken along line J-J′ in FIG. 33, of a room model in which a daylighting device and a lighting-modulation system are installed.

FIG. 33 is a plan view of a ceiling of the room model.

FIG. 34 is a graph representing a relationship between the illuminance produced by daylighting light (natural light) guided indoors by a daylighting device and the illuminance produced by room lighting devices (lighting-modulation system).

### DESCRIPTION OF EMBODIMENTS

### First Embodiment

The following will describe a daylighting device in accordance with a first embodiment of the present invention.

In each drawing introduced below, elements may be drawn with different scale ratios for easy recognition of the elements.

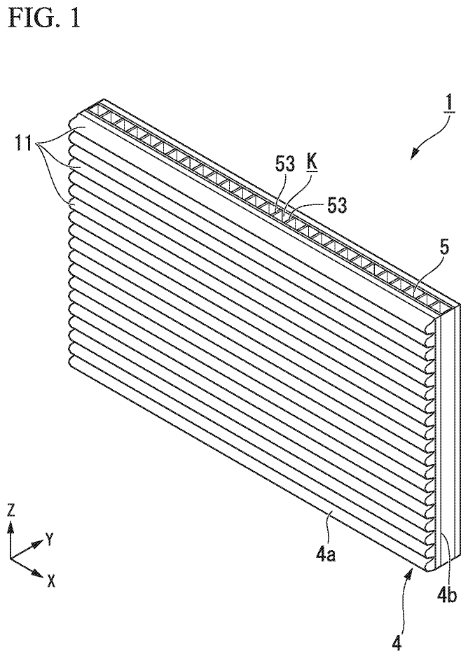

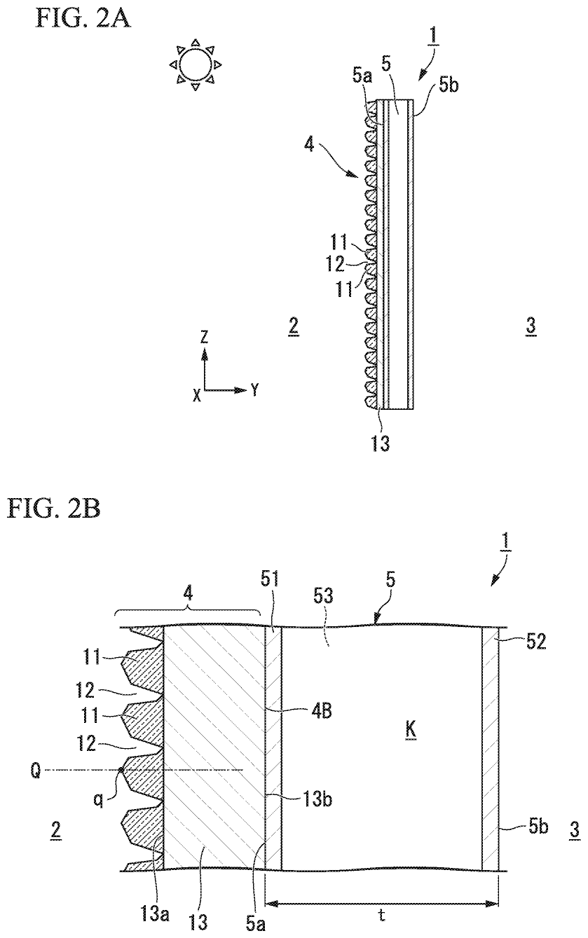

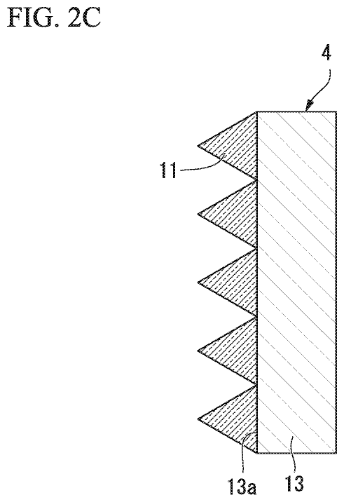

FIG. 1 is a perspective view of an overall structure of a daylighting device 1 in accordance with the first embodiment. FIG. 2A is a cross-sectional view of the overall structure of the daylighting device in accordance with the first embodiment. FIG. 2B is an enlarged cross-sectional view of a part of the daylighting device shown FIG. 2A.

The daylighting device 1 in accordance with the present embodiment is an example of a daylighting device that, when attached to a window, guides sunlight (outdoor light) into a room or a building. Referring to FIG. 1, the daylighting device 1 includes a translucent daylighting sheet 4 and a translucent hollow structural body 5. The hollow structural body 5 is disposed on a back face 4b of the daylighting sheet 4 opposite a light-receiving face 4a of the daylighting sheet 4. The hollow structural body 5 restrains warping of the daylighting sheet 4.

The daylighting sheet 4 has the light-receiving face 4a facing an exterior 2 of the room (see FIG. 2A) and the back face 4b facing an interior 3 (see FIG. 2A) throughout the present embodiment.

The hollow structural body 5 is preferably a transparent plate of, for example, a polycarbonate-based resin. The hollow structural body 5 preferably has a total light transmittance of at least 90% when measured as specified in JIS K7361-1, which may give sufficient transparency to the hollow structural body 5.

As shown in FIGS. 2A and 2B, daylighting sections 11 are tiny protrusions on the order of few tens of micrometers to a few hundreds of micrometers provided on a first face 13a of a support base member (base member) 13, in order to guide outdoor light (sunlight) into the interior 3. The daylighting sections 11 are arranged in stripes. The daylighting sections 11 are disposed one above the other (parallel to each other) so as to extend horizontally. Each daylighting section 11 has a polygonal shape in the cross-section taken perpendicular to the length thereof.

The daylighting sections 11 are fixed to a first face 5a of the hollow structural body 5 with the support base member 13 intervening therebetween. The support base member 13 transmits light. The present embodiment describes an example where the daylighting sections 11 are fixed to the hollow structural body 5 with the support base member 13 intervening therebetween. This structure is however by no means meant to limit the present invention. Alternatively, there may be provided an adhesion layer as an interface between the support base member 13 and the hollow structural body 5. As another alternative, the daylighting sections 11 may be disposed directly on one of the faces (first face 5a) of the hollow structural body 5.

Each daylighting section 11 is a polygonal-prism structural body with a hexagonal cross-section and is asymmetric with respect to line Q that passes through an apex q, a point on the daylighting section 11 removed farthest from the support base member 13, and that is perpendicular to the support base member 13, as shown in FIG. 2B. The cross-section of the daylighting section 11 has a smaller-than-180° interior angle at five out of the six vertices thereof.

The daylighting section 11 does not necessarily have the cross-sectional shape shown in FIG. 2B and may be designed so as to have a cross-sectional shape suited to the intended use and other requirements of the daylighting device 1. In other words, the daylighting section 11 may, for example, be triangular (see FIG. 2C) or have a curved line in the cross-section taken perpendicular to the length thereof, provided that the shape of the daylighting section 11 confers a daylighting function.

There are provided gap portions 12 between adjacent daylighting sections 11. The gap portions 12 contain air therein and therefore have a refractive index of approximately 1.0. Specifying the refractive index of the gap portions 12 to be 1.0 minimizes the critical angles of the interfaces of the gap portions 12 and the daylighting sections 11. The support base member 13 and the daylighting sections 11 preferably have approximately equal refractive indices for the following reasons. If there is a large difference between the refractive index of the support base member 13 and the refractive index of the daylighting sections 11, the light entering the daylighting sections 11 from the support base member 13 may undesirably be refracted or reflected at the interface of the daylighting sections 11 and the support base member 13. These phenomena could lead to unfavorable results, including reduced luminance and a failure to achieve a desirable daylighting capability. Specifying the refractive index of the support base member 13 and the refractive index of the daylighting sections 11 to have approximately equal values achieves a desirable daylighting capability, improves light use efficiency, and reduces uncomfortable reflection of light into the room interior 3.

The daylighting sections 11 are made of a transparent and photosensitive organic material such as an acrylic resin, an epoxy resin, or a silicone resin. These resins may be a mixed with, for example, a polymerization initiator, a coupling agent, a monomer, or an organic solvent, to obtain a mixture of transparent resins for use. The polymerization initiator may contain various additional components such as stabilizers, inhibitors, plasticizers, fluorescent whitening agents, release agents, chain transfer agents, and other photopolymerizable monomers.

The daylighting sheet 4 has a thickness of from 0.05 mm to 1.0 mm, preferably from 0.1 mm to 0.5 mm in the present embodiment.

The hollow structural body 5 is fixed a second face 13b of the support base member 13. The hollow structural body 5 includes a first wall section (first plate section) 51, a second wall section (second plate section) 52, and a plurality of structural bodies (ribs) 53. The second wall section 52 is positioned opposite the first wall section 51. The ribs 53 are disposed between, and sandwiched by, the first wall section 51 and the second wall section 52. Referring to FIG. 1, the ribs 53 extend in a direction along which the daylighting sections 11 are aligned in the daylighting sheet 4 (“direction of alignment” of the daylighting sections 11, or the “Z-direction”). The ribs 53 are also separated by equal intervals in a direction in which the daylighting sections 11 extend (“direction of extension” of the daylighting sections 11, or the “X-direction”).

Hollow portions K are formed between the ribs 53 as shown in FIGS. 1 and 2B. Each hollow portion K is a space surrounded by a pair of adjacent ribs 53 and 53, the first wall section 51, and the second wall section 52. The hollow structural body 5 in accordance with the present embodiment has a structure in which each hollow portion K is continuous along the direction of alignment of the daylighting sections 11 in the daylighting sheet 4 (Z-direction), that is, continuous along the top/bottom direction of the daylighting device 1.

The hollow structural body 5 (first wall section 51 and second wall section 52) is formed with such a size as to cover the back face 4b of the daylighting sheet 4. The hollow structural body 5 has the first wall section 51 thereof fixed onto the back face 4b of the daylighting sheet 4.

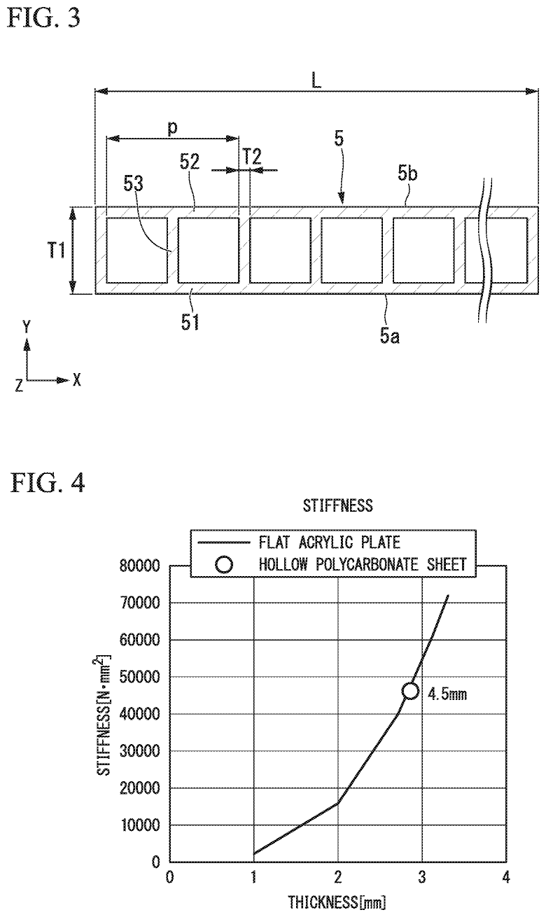

FIG. 3 is a cross-sectional view of the structure of the hollow structural body.

Referring to FIG. 3, the hollow structural body 5 has a thickness T1 of from 2 mm to 100 mm, preferably from 4 mm to 50 mm. The ribs 53 have a thickness T2 of from 0.05 mm to 0.5 mm, preferably from 0.2 mm to 0.4 mm. The ribs 53 have a pitch p of from 2 mm to 100 mm, preferably from 4 mm to 50 mm.

In an example of the hollow structural body 5 in accordance with the present embodiment, the thickness T1 of the hollow structural body 5 is 4.5 mm, the thickness T2 of the ribs 53 is 0.3 mm, and the pitch p of the ribs 53 is 7 mm. This hollow structural body 5 exhibits stiffness σ_{A} given by Equation 1 below.

In this context, the “thickness T1 of the hollow structural body 5” is measured in a direction that intersects the direction of alignment of the ribs 53 and refers to the distance between the first face 5a and a second face 5b of the hollow structural body 5. The “thickness T2 of the ribs 53” is measured in the direction of alignment of the ribs 53.

σ_{A}=(PL³)/(3EL) (1)

where P is a load, and L is a length.

The stiffness σ_{A} of the hollow structural body 5, which is an example of the present embodiment, is calculated from Equation 1, which is 44,080 N·mm².

Conventionally, a resin plate with a prescribed thickness is attached to the daylighting sheet 4 in order to restrain warping of the daylighting sheet 4. FIG. 4 is a diagram representing a relationship between the thickness and stiffness of a flat acrylic plate used as a resin plate. FIG. 4 indicates that a flat acrylic plate, if used as a resin plate, needs to have a thickness of 2.8 mm in order to give a stiffness that is approximately equal to the stiffness of the hollow structural body 5 of the present embodiment. In other words, a hollow polycarbonate sheet that is an example of the hollow structural body 5 having a thickness of 4.5 mm is an equivalent of a flat acrylic plate having a thickness of 2.8 mm in terms of resistance against deformation under external force.

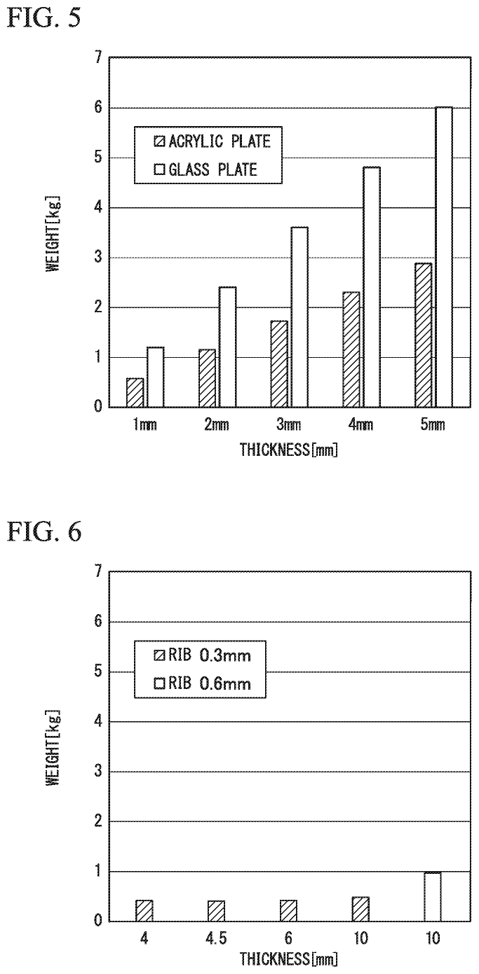

FIG. 5 is a diagram that shows a comparison of a relationship between the thickness and weight of a flat glass plate with that of a flat acrylic plate.

FIG. 5 indicates that if a flat acrylic plate is used to restrain warping of a daylighting sheet, it is possible to reduce weight approximately to half that of a flat glass plate. For example, if the flat glass plate has a thickness of 4 mm, the flat glass plate weighs approximately 4.8 kg, whereas if the flat acrylic plate has the same thickness, the flat glass plate weighs approximately 2.3 kg. In other words, the flat acrylic plate weighs approximately half the flat glass plate. Weight can be reduced by using a flat acrylic plate in place of a flat glass plate.

FIG. 6 is a diagram representing a relationship between the thickness and weight of a hollow structural body (hollow polycarbonate sheet). FIG. 6 shows a hollow structural body including 0.3-mm thick ribs and a hollow structural body including 0.6-mm thick ribs.

FIG. 6 indicates that the hollow polycarbonate sheet weighs far less than the solid flat acrylic plate. FIG. 6 also indicates that the hollow polycarbonate sheet that is as thick as 4 mm weighs only about 0.43 kg, which is approximately ⅕ the weight of the flat acrylic plate.

These observations demonstrate that the hollow structural body (hollow polycarbonate sheet) in accordance with the present embodiment is both lighter and stiffer than the flat acrylic plate.

Next, a description will be given of the installation environment and daylighting function of the daylighting device 1.

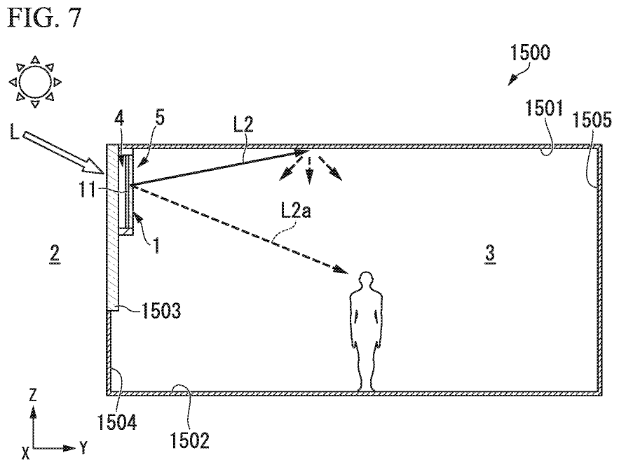

FIG. 7 is a schematic illustration of a room model 1500 where the daylighting device 1 is installed.

In the room model 1500 shown in FIG. 7, the daylighting device 1 is assumed to be used in an office room as an example. In the room model 1500, outdoor light L comes from an obliquely upward direction through a window pane 1503 into the interior 3 that is surrounded by a ceiling 1501, a floor 1502, a front wall 1504 where the window pane 1503 is installed, and a back wall 1505 opposite the front wall 1504. The daylighting device 1 is installed over the indoor side of an upper portion of the window pane 1503. Outdoor light L is incident to the window pane 1503 from an obliquely upward direction. The light incident to the window pane 1503 travels through the window pane 1503 and strikes the daylighting device 1.

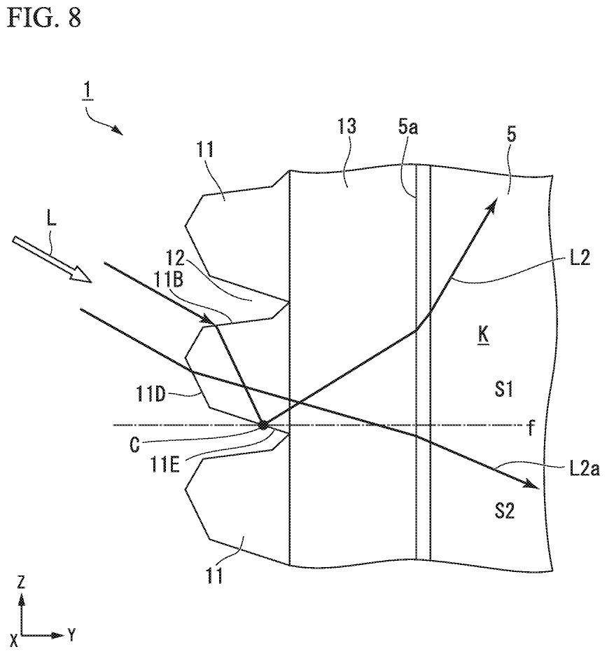

FIG. 8 is a cross-sectional view of the daylighting sections 11 of the daylighting device 1, illustrating an internal light-controlling function of the daylighting sections 11.

As shown in, for example, FIG. 8, some rays of light L that are incident to the daylighting device 1 strike upwardly tilted faces 11B of the daylighting sections 11 (“light L2”), and some strike downwardly tilted faces 11D (“light L2a”).

In the following description, an incident point C is a point at which a ray of light L2 striking the upwardly tilted face 11B of the daylighting section 11 hits a face 11E (reflection face) of the daylighting section 11. A straight line f is defined as a virtual straight line that passes through the incident point C and that is perpendicular to the first face 5a of the hollow structural body 5. A first space S1 is defined as one of the two spaces bordering at the horizontal plane containing the straight line f that contains the light hitting the incident point C, whilst a second space S2 is defined as the other one of the two spaces that contains no light hitting the incident point C.

Light L2, entering the daylighting section 11 through the upwardly tilted face 11B, undergoes total reflection at the face 11E of the daylighting section 11, then travels in an obliquely upward direction, that is, into the first space S1, and exits the daylighting section 11 through a face 11A of the daylighting section 11. After exiting the daylighting section 11, light L2 travels through the hollow structural body 5 and exits the hollow structural body 5 in the direction of the ceiling of the room's interior 3. The light leaving the daylighting device 1 in the direction of the ceiling is reflected by the ceiling and illuminates the interior of the room, which may fill the need for artificial lighting.

Each hollow portion K in the hollow structural body 5 in accordance with the present embodiment is continuous (i.e., forms a single hollow space) along the direction of alignment of the daylighting sections 11 in the daylighting sheet 4, that is, continuous in the vertical direction (Z-direction). Therefore, light L2 leaving the daylighting sections 11 hardly changes its optical path in the vertical direction.

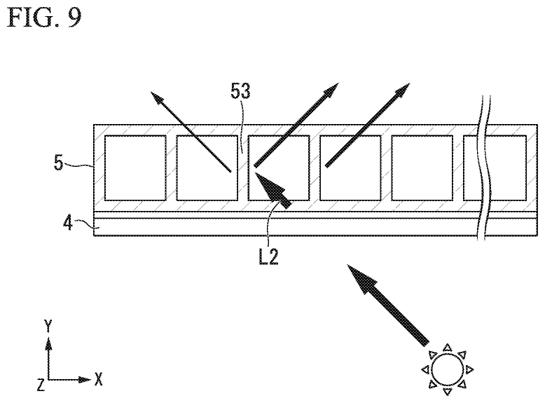

FIG. 9 is a cross-sectional view, taken parallel to the X-Y plane, of a daylighting sheet and a hollow structural body, showing optical paths of light passing through them.

While there are almost no vertical changes of optical paths in the hollow structural body 5, some rays of light L2 leaving the daylighting sheet 4 are scattered in horizontal directions (X-direction by a micro-scattering structure on the ribs 53 of the hollow structural body 5 upon hitting the ribs 53 as shown in FIG. 9. It is therefore possible to adjust the horizontal reflectance of the ribs 53 and the horizontal traveling direction of light reflected by the ribs 53 by designing the ribs 53 in a suitable manner.

As mentioned earlier, the daylighting sheet 4 could thermally contract and warp under sunlight. The warping of the daylighting sheet 4 can be restrained by attaching a resin plate. If the resin plate is thin, however, the resin plate is mechanically too weak to restrain the daylighting sheet 4 from warping under its own weight or under the stress that occurs when the daylighting sheet 4 is attached. The daylighting sheet 4 warps, if at all, in the direction of alignment the daylighting sections 11, that is, in the vertical direction (Z-direction, rather than in the other directions. The warping would change the optical path of light passing through the daylighting sheet 4, thereby impairing the intended daylighting effect of the daylighting sheet. A resin or glass plate with some thickness may be attached in order solely to restrain warping of the daylighting sheet 4. However, as mentioned earlier, attaching a flat acrylic or glass plate to the daylighting sheet 4 adds to the total weight, which in turn requires extra cost and a heavy job to install the daylighting device over the window.

In contrast, attaching to the daylighting sheet 4 the hollow structural body 5 of the present embodiment composed of, for example, polycarbonate can efficiently restrain warping of the daylighting sheet 4 and hugely reduce the total weight without compromising on the mechanical strength of the hollow structural body 5.

The daylighting sheet 4 is thus prevented from warping effectively over a long term and capable of sufficiently exhibiting its intended daylighting effect. Additionally, the total weight is reduced, which enables easy handling. The daylighting device can be readily installed over the window at a lower cost.

### DAYLIGHTING DEVICE INSTALLATION EXAMPLES

### Example 1

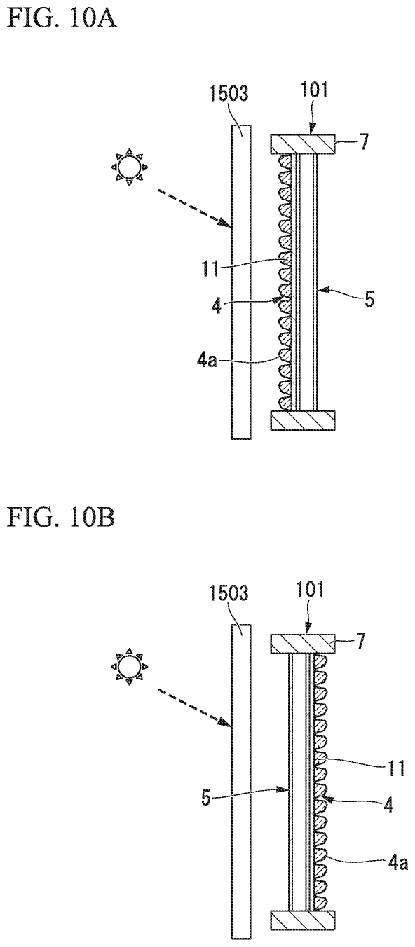

FIG. 10A shows a structure of Example 1 of the daylighting device in accordance with the first embodiment.

A daylighting device 101 of Example 1, as shown in FIG 10A, includes a frame 7 that holds the attached daylighting sheet 4/hollow structural body 5. The daylighting device 101 is installed, for example, on a part of the ceiling near the window. The daylighting device 101 may be installed, as shown in FIG. 10A, with the light-receiving face 4a of the daylighting sheet 4 facing outdoors (i.e., facing the window pane 1503) and the hollow structural body 5 facing indoors.

### OTHER DAYLIGHTING DEVICE INSTALLATION EXAMPLES

FIG. 10B shows an additional installation example of the daylighting device 101 in accordance with Example 1.

The daylighting device 101 may be installed, as shown in FIG. 10B, with the light-receiving face 4a of the daylighting sheet 4 facing indoors and the hollow structural body 5 facing outdoors (i.e., facing the window pane 1503).

### Example 2

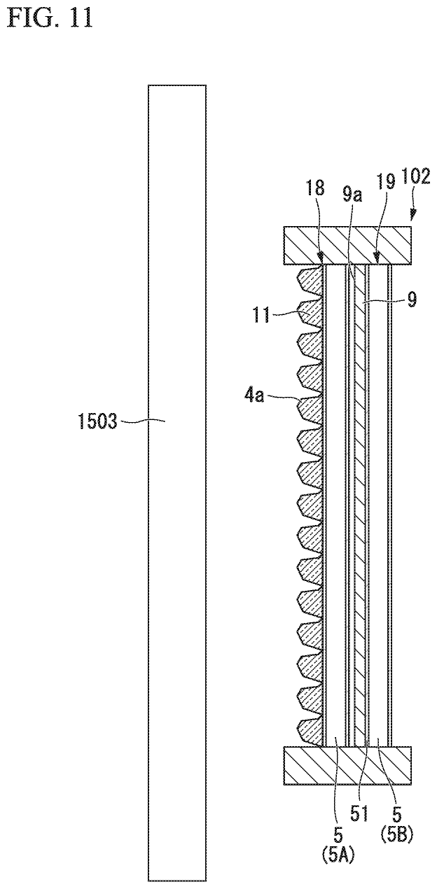

FIG. 11 shows a structure of Example 2 of the daylighting device in accordance with the first embodiment.

A daylighting device 102 of Example 2, as shown in FIG. 11, includes a daylighting sheet 18 and a light-diffusion member 19. The hollow structural body 5 may be applied to the base member of the daylighting sheet 18 and to the base member of the light-diffusion member 19, which means that a plurality of daylighting sections 11 may be formed integrally with one of the hollow structural bodies 5 on the outdoor-side surface of that hollow structural body 5. In this example, the daylighting sheet 18 includes a hollow structural body 5A having a first wall section 51 on the outdoor-side surface of which is there formed a plurality of daylighting sections 11.

If the light-diffusion member 19 is built around a lenticular lens array, the light-diffusion member 19 may include a hollow structural body 5B having a first wall section 51 on the outdoor-side surface of which is there formed a plurality of lenticular lenses 9.

This structure restrains warping of the daylighting sheet 18 and reduces the weight of the daylighting sheet 18, and also reduces the weight of the light-diffusion member 19. The additional inclusion of the light-diffusion member 19, besides the daylighting sheet 18, enhances the light-diffusion effect. In this example, the daylighting device 102 may be installed, as shown in FIG. 11, with the light-receiving face 4a of the daylighting sheet 18 and a light-diffusion face 9a of the light-diffusion member 19 both facing outdoors (i.e., facing the window pane 1503).

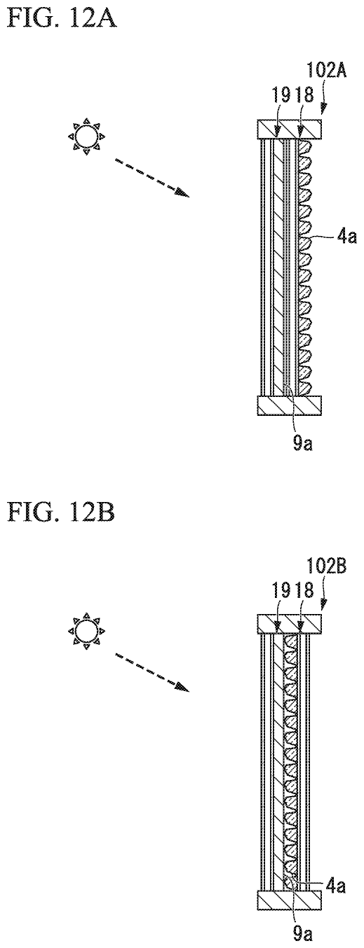

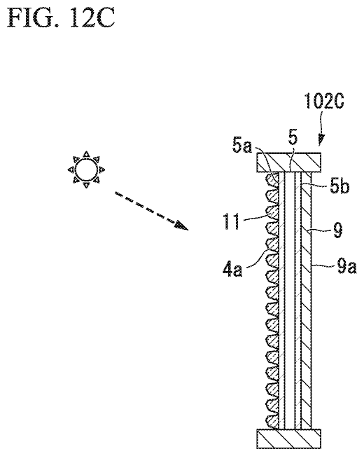

FIGS. 12A to 12C each show a variation example of the daylighting device of Example 2.

The light-diffusion member 19 may be disposed on the outdoor side of the daylighting sheet 18 as in a daylighting device 102A shown in FIG. 12A, in which case the daylighting device 102A is installed with the light-receiving face 4a of the daylighting sheet 18 and the light-diffusion face 9a of the light-diffusion member 19 facing indoors.

Alternatively, the daylighting sheet 18 and the light-diffusion member 19 may be disposed such that their functional surfaces face each other, as in a daylighting device 102B shown in FIG. 12B. This structure in which the light-receiving face 4a of the daylighting sheet 18 and the light-diffusion face 9a of the light-diffusion member 19 face each other inside the daylighting device 102B provides protection to their optical functional surfaces.

As another alternative, the hollow structural body 5 may be provided with an optical functional surface on both sides thereof. For example, as in a daylighting device 102C shown in FIG. 12C, the hollow structural body 5 may include a plurality of daylighting sections 11 on the first face 5a (e.g., outdoor-side surface) so that the first face 5a can function as a light-receiving face and further include a plurality of lenticular lenses 9 on the second face 5b (e.g., indoor-side surface) the second face 5b can function as a light-diffusion face. As a further alternative, the daylighting sheet 18 and the light-diffusion member 19 may be attached on different sides of a single hollow structural body 5 in an integrated manner.

These structures restrain warping of the daylighting sheet 18 more effectively. The provision of both the daylighting sheet 18 and the light-diffusion member 19 on a single, common hollow structural body 5 further reduces weight and cost.

### Example 3

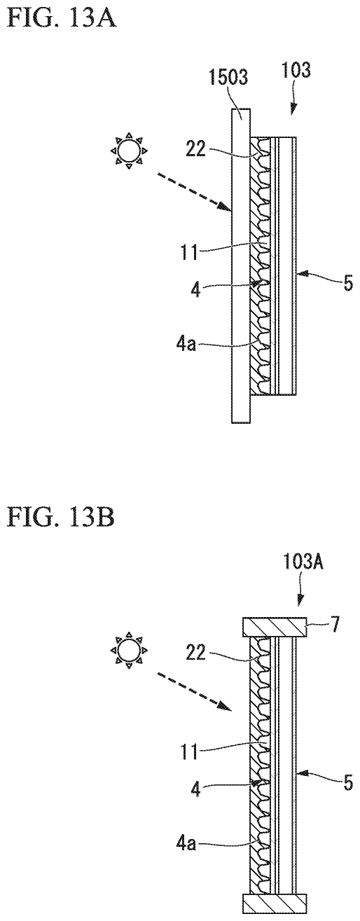

FIG. 13A shows a structure of Example 3 of the daylighting device in accordance with the first embodiment. FIG. 13B shows a variation example of a daylighting device of Example 3.

Referring to FIG. 13A, the daylighting sheet 4 may include, on the light-receiving face 4a thereof, a low-refractive-index resin 22 that has a refractive index roughly equal to that of air, so as to seal the daylighting sections 11. This structure enables the daylighting sheet 4 to be attached, on the light-receiving face 4a thereof, directly to the window pane 1503. The low-refractive-index resin 22 also provides protection to the light-receiving face 4a. Alternatively, the daylighting device in accordance with the first embodiment may be installed on a ceiling via the frame 7 as is the case with a daylighting device 103A shown in FIG. 13B.

These examples use a lenticular lens array as the light-diffusion member 8. The light-diffusion member 8 may be any member that provides a light-diffusing function.

### Second Embodiment

Next will be described a daylighting device in accordance with a second embodiment of the present invention.

The daylighting device in accordance with the present embodiment detailed in the following has substantially the same, basic structures the daylighting device in accordance with the first embodiment and differs in that the former includes ribs subjected to high-reflection processing. The following description will therefore focus on differences from the first embodiment and may not elaborate much on common features. Elements that are common to FIGS. 1 to 13B and the drawings used in the description of the present embodiment are denoted by the same reference signs.

FIG. 14 is a cross-sectional view, taken parallel to the X-Y plane, of a structure of a daylighting device 20 in accordance with the second embodiment.

The daylighting device 20 in accordance with the present embodiment as shown in FIG. 14, includes a hollow structural body 25 including ribs 23 with a high optical reflectance. The ribs 23 have been subjected to high-reflection processing in a suitable manner. The high-reflection processing needs only to be capable of increasing the visible-light reflectance of the ribs 23 over that of a flat film of the same resin. Preferably, the ribs 23 are made to serve as a half mirror by means of a metal film, as an example. By subjecting the ribs 23 to suitable high-reflection processing, the ribs 23 become capable of reflecting, to the left/right directions in the room, the light that strikes the daylighting device 20 from oblique directions. Therefore, this structure can diffuse light across the whole room. Not all the ribs 23 need to be subjected to high-reflection processing. Only some of the ribs 23 may be subjected to high-reflection processing.

### Third Embodiment

Next will be described a daylighting device in accordance with a third embodiment of the present invention.

The daylighting device in accordance with the present embodiment detailed in following has substantially the same basic structure as the daylighting device in accordance with the first embodiment and differs in that the former includes ribs subjected to high-reflection processing. The following description will therefore focus on differences from the first embodiment and may not elaborate much on common features. Elements that are common to FIGS. 1 to 13B and the drawings used in the description of the present embodiment are denoted by the same reference signs.

Examples of the daylighting device of the present embodiment will be described now.

### Example 1

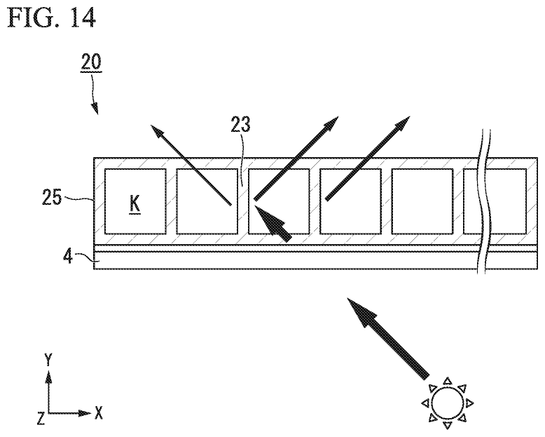

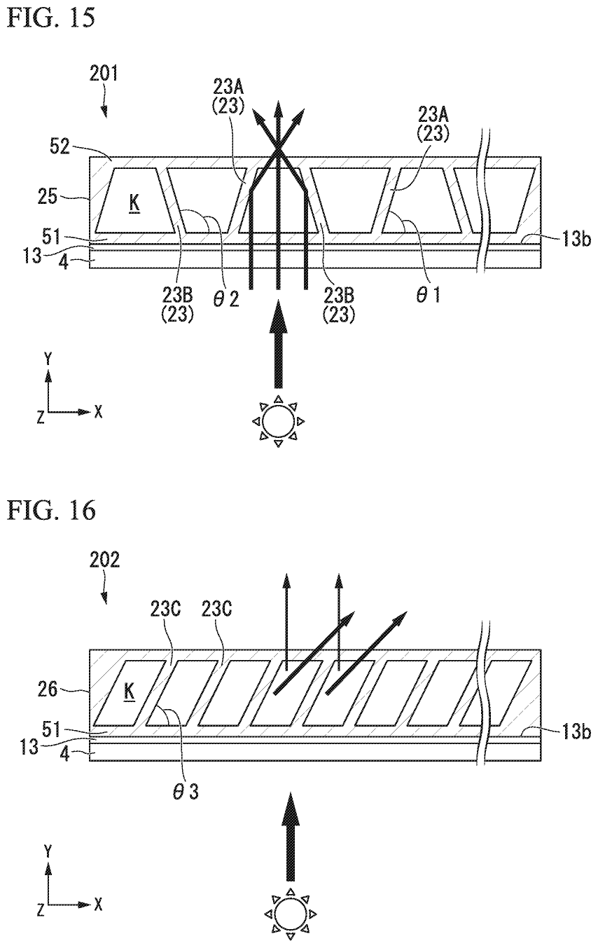

FIG. 15 is a cross-sectional view, taken parallel to the X-Y plane, of a structure of Example 1 of the daylighting device in accordance with the third embodiment.

As shown in FIG. 15, the daylight device in accordance with the third embodiment may be a daylighting device 201 including a hollow structural body 25 in which those ribs 23 that are adjacent in the X-direction have different angles of inclination. In this example, a rib 23A and a rib 23B are provided alternately along the X-direction. Each rib 23A inclines by a first angle θ1 with respect to the first wall section 51 of the hollow structural body 25 (the second face 13b of the support base member 13). Each rib 23B inclines by a second angle θ2 with respect to the first wall section 51 are provided alternately along the X-direction. This structure forms trapezoidal hollow portions K in the hollow structural body 25 when viewed from the Z-direction. The orientation of the trapezoidal shape is reversed in the Y-direction from one hollow portion K to the next when viewed along the X-direction.

This structure in which the ribs 23A and 23B incline by different angles is capable of, for example, controlling of the horizontal traveling direction (emission angle) of the reflection of the light striking the daylighting device right from the front.

### Example 2

FIG. 16 is a cross-sectional view, taken parallel to the X-Y plane, of a structure of Example 2 of the daylighting device in accordance with the third embodiment.

As shown in FIG. 16, the daylighting device in accordance with the third embodiment may be a daylighting device 202 including a hollow structural body 26 in which there is provided a plurality of ribs 23C inclining by a prescribed angle in the same direction with respect to the first wall section 51.

This structure enables the ribs 23C to reflect light in a direction that needs to be lit up, by setting the angle of the ribs 23C appropriately for the intended use. All the ribs 23C in this example incline by a third angle θ3 with respect to the first wall section 51 of the hollow structural body 26 (the second face 13b of the support base member 13). The structure is therefore capable of, reflecting more of the light striking the daylighting device right from the front to the right-hand side of the figure.

All the ribs in the hollow structural body incline in Examples 1 and 2 above. Alternatively, at least some of the ribs may incline. Such an example is given next.

### Example 3

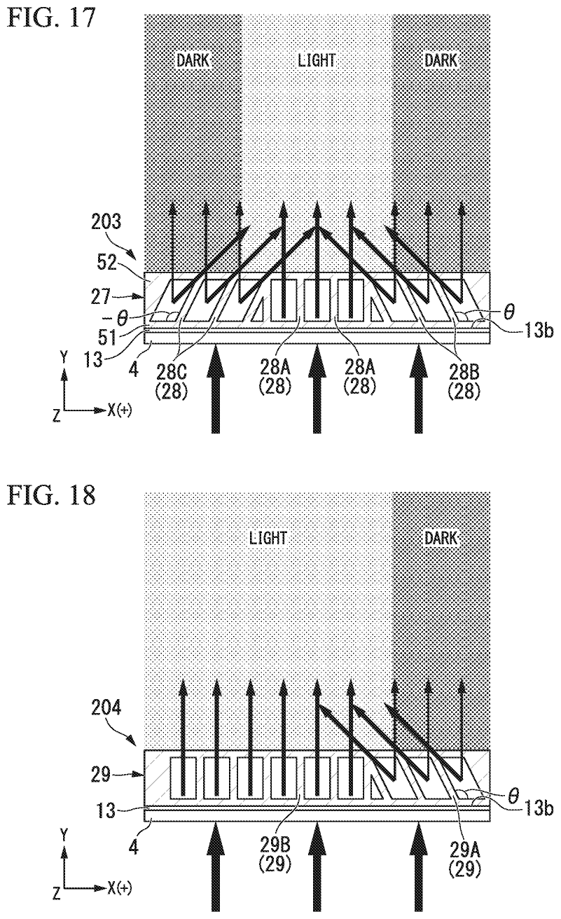

FIG. 17 is a cross-sectional view, taken parallel to the X-Y plane, of a structure of Example 3 of the daylighting device in accordance with the third embodiment.

As shown in FIG. 17, the daylighting device in accordance with the third embodiment may be a daylighting device 203 including a hollow structural body 27 in which there is provided a plurality of ribs 28 inclining by different angles. Ribs 28A that are in the middle portion of the hollow structural body 27 along its length (X-direction) are perpendicular to the first wall section 51. Meanwhile, ribs 28B that are on the right-hand side of the figure (toward the positive end of the X-direction) incline by a prescribed angle θ with respect to the first wall section 51 (the second face 13b of the support base member 13). In addition, ribs 28C that are on the left-hand side of the figure (toward the negative end of the X-direction) incline by a prescribed angle −θ with respect to the first wall section 51. FIG. 17 shows that the ribs 28B and the ribs 28C incline by symmetric angles with respect to the normal to the first wall section 51, which by no means limits the scope of the invention. Alternatively, the ribs 28B and the ribs 28C may have different angles of inclination with respect to the normal.

### Example 4

FIG. 18 is a cross-sectional view, taken parallel to the X-Y plane, of a structure of Example 4 of the daylighting device in accordance with the third embodiment.

As shown in FIG. 18, the daylighting device in accordance with the third embodiment may be a daylighting device 204 including a hollow structural body 29 in which there is provided, toward one of the ends of the hollow structural body 29 in terms of the X-direction (e.g., on the right-hand side of the figure, or toward the positive end of the X-direction), a plurality of ribs 29A inclining by a prescribed angle θ with respect to the first wall section 51. Other, majority ribs 29B are perpendicular to the first wall section 51 (the second face 13b of the support base member 13). This structure enables the ribs 28B to refract, to the left-hand side of the room (left-hand side of the figure), most of the light passing through a portion of the hollow structural body 29 where the ribs 28B exist, which leaves little light traveling on straightly. Therefore, the daylighting device 204 is capable of directing more light to the center and the left-hand side of the room (left-hand side of the figure), thereby lighting up a desired part of the room.

If more light needs to be directed to the center and the right-hand side of the room (right-hand side of the figure), those ribs located toward the other end of the hollow structural body 29 in terms of the X-direction length (e.g., on the left-hand side of the figure, or toward the negative end of the X-direction) are simply inclined by −θ.

Hence, the traveling directions of light directed to the interior of the room can be controlled by adjusting the angles of inclination of the ribs. That in turn enables the light to be guided to a part of the room that needs to be lit up.

The ribs of Example 1 to 4 may be subjected to suitable high-reflection processing. As an example of such high-reflection processing, the ribs may be processed so that they can serve as a half mirror. This processing enables most of the incident light from the front to be guided to or around the center of the room. Thus, the central part of the room where occupants of the room tend to gather can be lit up more brightly. As in the previous embodiment, not all the ribs need to be subjected to high-reflection processing. Only some of the ribs may be subjected to high-reflection processing.

### Fourth Embodiment

Next will be described a daylighting device 30 in accordance with a fourth embodiment of the present invention.

The daylighting device 30 in accordance with the present embodiment detailed in the following has substantially the same basic structure as the daylighting device in accordance with the first embodiment and differs in that the former includes ribs that do not have a uniform thickness. The following description will therefore focus on differences from the first embodiment and may not elaborate much on common features. Elements that are common to FIGS. 1 to 13B and the drawings used in the description of the present embodiment are denoted by the same reference signs.

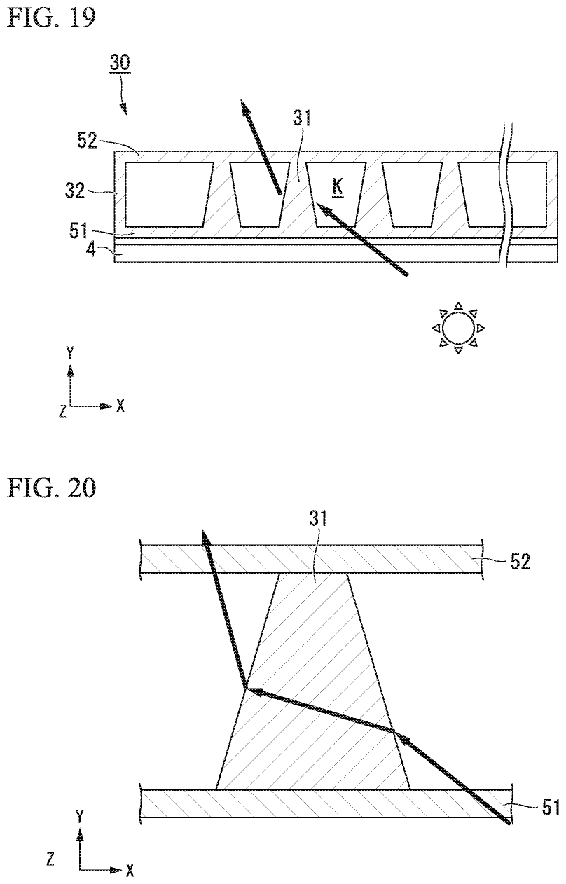

FIG. 19 is a cross-sectional view, taken parallel to the X-Y plane, of a structure of the daylighting device 30 in accordance with the fourth embodiment.

FIG. 20 is a cross-sectional view, taken parallel to the X-Y plane, of one of ribs 31 in hollow structural body 32 in accordance with the fourth embodiment

As shown in FIGS. 19 and 20, the daylighting device 30 in accordance with the present embodiment includes the hollow structural body 32 in which there is provided a plurality of ribs 31 that are trapezoidal in the cross-sectional view thereof taken parallel to the X-Y plane. The ribs 31 have a trapezoidal shape with a width that increases toward the first wall section 51 and decreases toward the second wall section 52. Because the hollow structural body 32 is formed by extrusion molding, it is easy to design the cross-sectional shape of the ribs 31.

Some of the light that strikes the daylighting device 30 from oblique directions enters the ribs 31 and refracts in the ribs 31 in the direction of the interior of the room (Y-direction) before leaving the daylighting device 30. The horizontal emission angles of light can be controlled in the present embodiment by appropriately designing the cross-sectional shape of the ribs 31. Thus, optical paths can be altered to any direction by means of refraction of light inside the ribs 31. Light can be therefore guided in directions that need to be lit up in accordance with the intended use of the room.

The present embodiment has assumed that the ribs 31 have a trapezoidal cross-sectional shape, which by no means limits the scope of the invention.

The following give some examples of a hollow structural body included in the daylighting device 30 in accordance with the present embodiment.

### Example 1

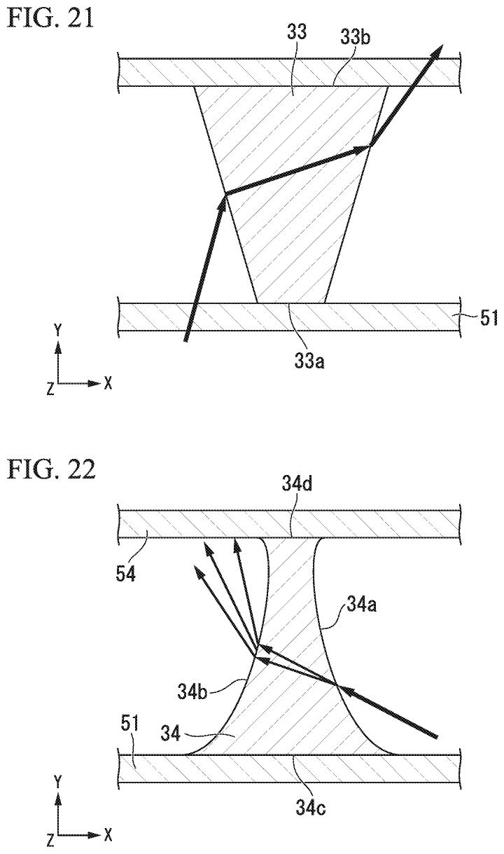

FIG. 21 is a cross-sectional view, taken parallel to the X-Y plane, of a structure of a major part (shape of a rib) of a hollow structural body of Example 1 of the fourth embodiment.

A rib 33 shown in FIG. 21 has the same shape as the rib 31 shown in FIG. 20 reversed in the Y-direction. The rib 33 has a trapezoidal shape with a width that gradually increases from the end thereof on the first wall section 51 toward the end thereof on the second wall section 52. By forming ribs with such a shape where the length along the X-direction (width) is larger on a second end face 33b (exit end) than on a first end face 33a (entrance end), the azimuth of emission of the light passing through the rib 33 can be increased. In other words, this rib shape with a width that increases toward the indoor side enables the incident light substantially from the front of the daylighting device (hollow structural body) to refract such that the light can spread horizontally (in the X-direction). The structure therefore can spread light in the left/right directions in the room to light up the whole room.

### Example 2

FIG. 22 is a cross-sectional, taken parallel to the X-Y plane, of a structure of a major part (shape of a rib) of a hollow structural body of Example 2 of the fourth embodiment.

Each rib 34 may have side faces 34a and 34b curved in such a manner that the rib 34 is concave in the thickness direction as shown in FIG. 22. The rib 34 has a first end face 34c on the first wall section 51 side and a second end face 34d on the second wall section 52 side opposite the first end face 34c. The rib 34 has a length along the X-direction (width) that is smaller on the second end face 34d (exit end) than on the first end face 34c (entrance end). This structure diffuses the light passing through the rib 34, for example, when the light hits the side faces 34a and 34b, which spread the light exiting the rib 34 in horizontal directions (X-direction).

### Example 3

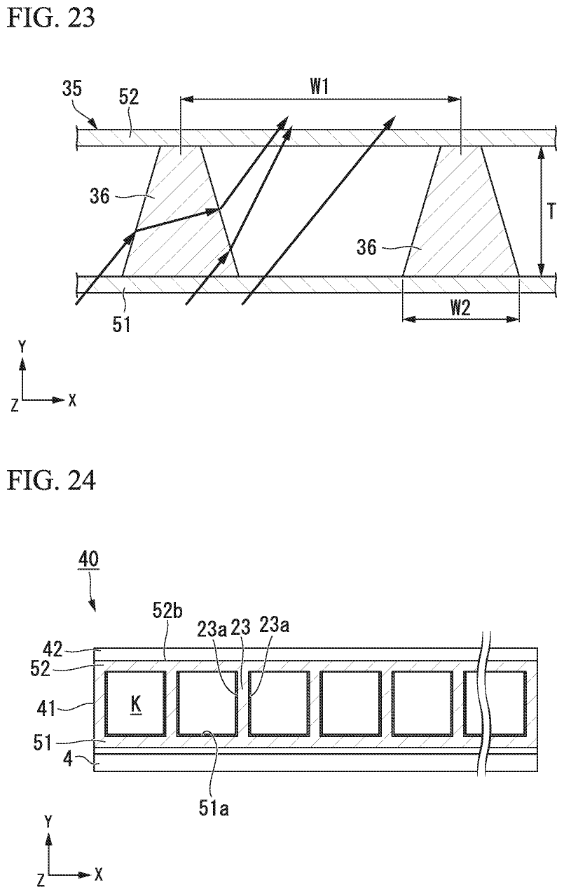

FIG. 23 is a cross-sectional view, taken parallel to the X-Y plane, of a structure of a major part (shape of a rib) of a hollow structural body of Example 3 of the fourth embodiment.

In a hollow structural body 35 shown in FIG. 23, adjacent ribs 36 are separated by a distance W1 that is larger than a rib width W2 of each rib. Some of the light that strikes the hollow structural body 35 enters the ribs 36 and refracts in the ribs 36 in directions that need to be lit up (e.g., in the direction of the central part of the room). Meanwhile, the remaining light, hitting portions between the ribs 36 (non-rib regions), undergoes almost no refraction and passes through the hollow structural body 35 without changing its traveling direction.

The structure of the present example enables the optical path of exit light to be adjusted by adjusting in a suitable manner the distance W1 between the ribs 36, the rib width W2 of the ribs 36, and the thickness T of the ribs 36 on the first wall section 51 and the second wall section 52. Therefore, it is possible to adjust the optical path of exit light appropriately for the intended use solely by means of the structure of the hollow structural body 5 without having to alter the above-described design of the daylighting sheet 4 and the light-diffusion member 8.

### Fifth Embodiment

Next will be described a daylighting device in accord a fifth embodiment of the present invention.

The daylighting device in accordance with the present embodiment detailed in the following has substantially the same basic structure as the daylighting device in accordance with the first embodiment and differs in that the former includes a hollow structural body that has a micro-scattering function therein. The following description will therefore focus on differences from the first embodiment and may not elaborate much on common features. Elements that are common to FIGS. 1 to 13B and the drawings used in the description of the present embodiment are denoted by the same reference signs.

FIG. 24 is a cross-sectional view, taken parallel to the X-Y plane, of a structure of a daylighting device 40 in accordance with the fifth embodiment.

As shown in FIG. 24, the daylighting device 40 in accordance with the present embodiment includes a daylighting sheet 4, a hallow structural body 41, and an anisotropic light-diffusion film 42.

The hollow structural body 41 includes a micro-scattering structure on an inner face 51a of the first wall section 51 and on both side faces 23a and 23a of each rib 23. The anisotropic light-diffusion film 42 that anisotropically diffuses light is provided on an outer face 52b of the second wall section 52 of the hollow structural body 41. The anisotropic light-diffusion film 42 needs only to diffuse light horizontally (in the X-direction) and may be built, as an example, around a light-diffusion member that includes many lenticular lenses as described earlier.

Upon hitting the daylighting device 40 in accordance with the present embodiment, light is scattered in random directions by the micro-scattering structure of the hollow structural body 41 and subsequently diffused horizontally (in the X-direction) by the anisotropic light-diffusion film 42 disposed on the exit end, before leaving the daylighting device 40 into the room.

This combination of the micro-scattering function provided on inner wall faces of the hollow structural body 41 (including the inner face 51a of the first wall section 51 and both side faces 23a and 23a of each rib 23) and the horizontal diffusion function of the anisotropic light-diffusion film 42 produces and directs suitable scattered light into the room. This structure can therefore restrain glaring light for occupants of the room.

The micro-scattering function of inner wall faces of the hollow structural body 41 can still provide an exit-light-diffusing function even if an optical film is attached to both sides of the hollow structural body 41.

### Sixth Embodiment

Next will be described a daylighting device in accordance with a sixth embodiment of the present invention.

The daylighting device in accordance with the present embodiment detailed the following has substantially the same basic structure as the daylighting device in accordance with the first embodiment and differs in that the former includes a hollow structural body that has an anisotropic light-diffusing function. The following description will therefore focus on differences from the first embodiment and may not elaborate much on common features. Elements that are common to FIGS. 1 to 13B and the drawings used in the description of the present embodiment are denoted by the same reference signs.

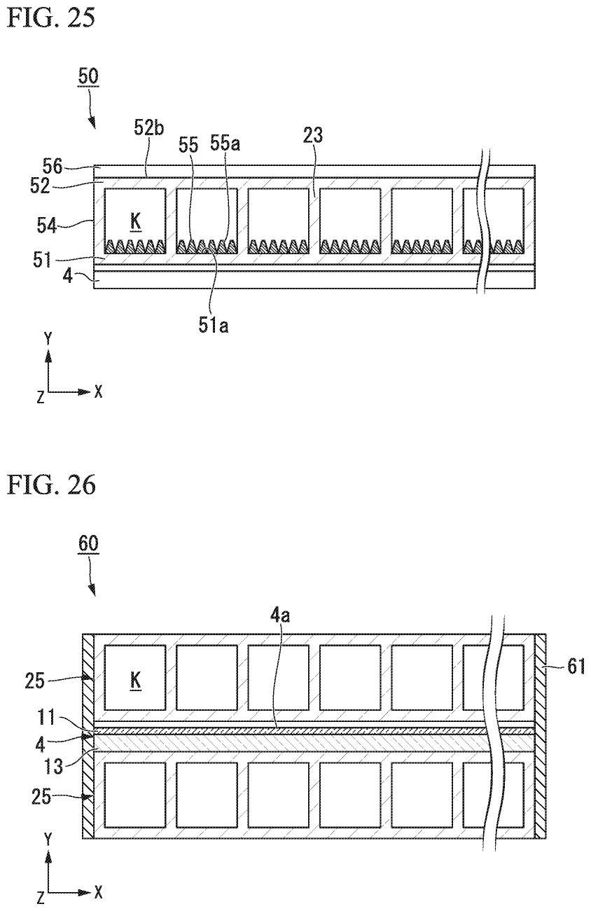

FIG. 25 is a cross-sectional view, taken parallel to the X-Y plane, of a structure of a daylighting device 50 in accordance with the sixth embodiment.

As shown in FIG. 25, the daylighting device 50 in accordance with the present embodiment includes a hollow structural body 54 in which an irregular structure 55 is formed on the inner face 51a of the first wall section 51. The irregular structure 55 includes a large number of ridge portions 55a extending along the direction of extension of the ribs 23 (Z-direction) and coupled together in the direction of alignment of the ribs 23 (X-direction). The irregular structure 55 has a function of diffusing light horizontally (in the X-direction). The numerous ridge portions 55a, arranged in vertical stripes, can impart only an anisotropic light-diffusing function to the inner face 51a of the hollow structural body 54. This structure enables light diffusion adjustment by providing a micro-scattering film 56 on the second wall section 52 located on the light-emitting side of the hollow structural body 54.

### Seventh Embodiment

Next will be described a daylighting device in accordance with a seventh embodiment of the present invention.

The daylighting device in accordance with the present embodiment detailed in the following has a daylighting-sheet-protection function.

FIG. 26 is a cross-sectional view, taken parallel to the X-Y plane, of a structure of a daylighting device 60 in accordance with the seventh embodiment.

As shown in FIG. 26, the daylighting device 60 in accordance with the present embodiment includes a frame 61 that holds together the daylighting sheet 4 and a pair of hollow structural bodies 25 and 25 that sandwiches the daylighting sheet 4. The provision of the daylighting sheet 4 between the pair of hollow structural bodies 25 and 25 can protect the light-receiving face 4a of the daylighting sheet 4 from foreign objects (e.g., exterior dust). The structure therefore helps maintain the daylighting function of the daylighting sheet 4 over a long term.

The daylighting sheet 4 may be sandwiched between the pair of hollow structural bodies 25 and 25 in such manner as to leave a gap on the light-receiving face 4a of the daylighting sheet 4. The resultant structure includes a layer of air between the pair of hollow structural bodies 25 and 25, making it possible to exploit refraction of light for daylighting purposes.

The pair of hollow structural bodies 25 and 25 and the frame 61 may be formed integrally by extrusion molding in the present embodiment.

The hollow structural bodies 25 may have different top and bottom dimensions. The daylighting sheet 4 may be either entirely or partially fixed to the hollow structural body 25 by using, for example, adhesive.

The following will describe an example of the daylighting device of the present embodiment.

### Example 1

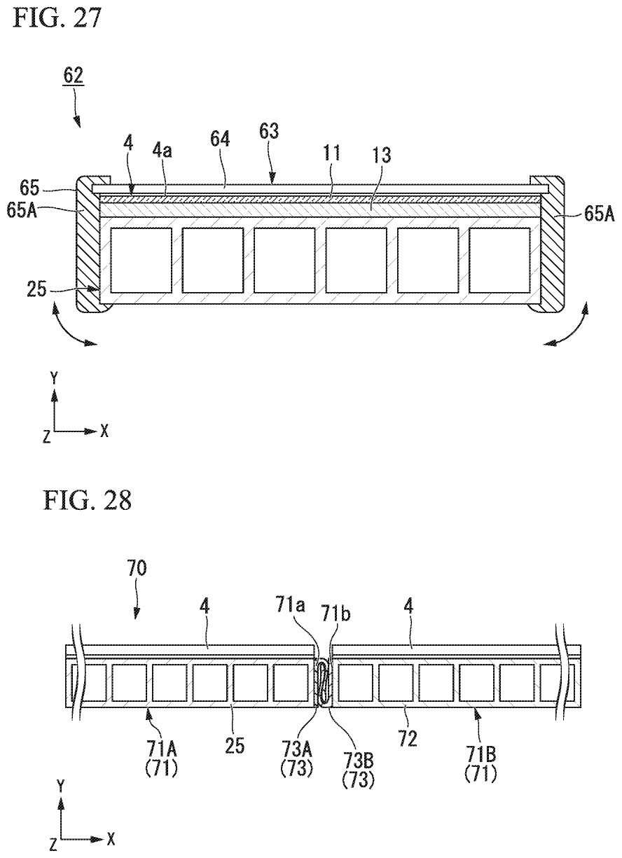

FIG. 27 is a cross-sectional view, taken parallel to the X-Y plane, of a structure of Example 1 of the daylighting device in accordance with the seventh embodiment.

As shown in FIG. 27, a daylighting device 62 in accordance with present Example 1 includes a daylighting sheet 4, a hollow structural body 25, and a protection member 63. The protection member 63 includes a transparent protection sheet 64 covering the light-receiving face 4a of the daylighting sheet 4 and holding members 65 holding the protection sheet 64. The holding members 65 can elastically deform at least in directions in which a pair of opposing grip portions 65A, 65A moves closer to, and away from, each other (indicated by arrows in the figure. The holding members 65 are capable of mating with and holding the daylighting sheet 4 and the hollow structural body 25 therein with a suitable gripping force.

This structure includes a gap between the protection sheet 64 and the light-receiving face 4a of the daylighting sheet 4. The layer of air between the protection sheet 64 and the light-receiving face 4a makes it possible to exploit refraction of light for daylighting purposes.

### Eighth Embodiment

Next will be described a daylighting device in accordance with an eighth embodiment of the present invention.

A daylighting device 70 in accordance with the present embodiment includes a plurality of daylighting members 71 coupled to each other.

This structure enables adjustment of the size of the daylighting device by changing the number of daylighting sheets in accordance with the window size and the intended use.

FIG. 28 is a schematic cross-sectional view, taken parallel to the X-Y plane, of a structure of the daylighting device 70 in accordance with the eighth embodiment.

The daylighting device 70 shown in FIG. 28 includes two types of daylighting members 71A, 71B that can be coupled to each other. Each daylighting member 71A, 71B includes a daylighting member 71 and a coupling section 73. The daylighting member 71 includes a daylighting sheet 4 and a hollow structural body 25. The coupling section 73 is disposed on aide of a hollow structural body 72.

There are provided a coupling section 73A on one of side faces 71a of the daylighting member 71A that are perpendicular to the X-direction and a coupling section 73B on another side face 71b of the daylighting member 71A that is perpendicular to the X-direction. The coupling section 73A and the coupling section 73B are symmetric with respect to the coupling direction, so that they can mate with each other to couple the daylighting members 71, 71 together.

The coupling sections 73 may be formed either integrally with the hollow structural body 72 from the same material by injection molding or separately from the hollow structural body 72.

The present embodiment has so far described that there is provided a coupling section 73 on one of the side faces of each daylighting member 71. Alternatively, there may be provided a coupling section 73 on either side face of each daylighting member 71. As another alternative, there may be provided a coupling section 73 on either the top face or the bottom face of each daylighting member 71, so that the top-to-bottom dimension of the daylighting device 70 can be adjusted. As a further alternative, there may be provided a coupling section 73 on these four faces of each daylighting member 71.

Each daylighting member 71A, 71B may be a hollow structural body 25 having a fine structure formed directly on one of its surfaces.

### Example 1

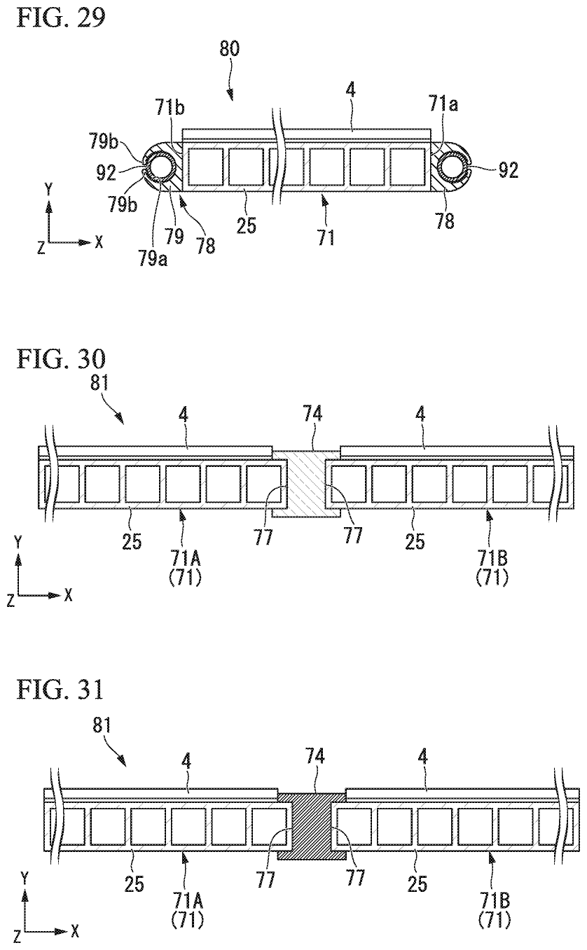

FIG. 29 is a cross-sectional view, taken parallel to the X-Y plane, of a structure of Example 1 of the daylighting device in accordance with the eighth embodiment.

A daylighting device 80 shown in FIG. 29 includes a daylighting member 71 with a coupling section 78 being provided on each side face 71a, 71b thereof that is perpendicular to the width direction. The coupling section 78 has an insertion hole 79a through which a support rod (coupling section) 92 erected, for example, on a floor is to be inserted. The coupling section 78 includes a tubular portion 79 that is to be engaged with the support rod 92 and secured thereon at a desirable height. Once the desirable height for the daylighting device is determined, a screw (not shown) is fastened that runs through a pair of claws 79b, 79b on the tubular portion 79. That in turn narrows the gap between the support rod 92 and the tubular portion 79 so that the tubular portion 79 can fit tightly around the support rod 92. This structure enables a plurality of daylighting members 71 to be arranged on top of each other along the length of the support rods 92. The structure can therefore adjust the top-to-bottom dimension of the daylighting device 80.

The coupling section 78 may be formed either separately from the hollow structural body 25 or integrally with the hollow structural body 25 from the same material.

### Example 2

FIG. 30 is a cross-sectional view, taken parallel o the X-Y plane, of a structure of Example 2 of the daylighting device in accordance with the eighth embodiment.

A daylighting device 81 shown in FIG. 30 includes a plurality of daylighting members 71 coupled together by a coupling implement (coupling section) 74 that is provided as a separate member. The coupling implement 74 is shaped like a bar having a length parallel to the Z-direction and includes a pair of concave insertion sections 77, 77 on its that are perpendicular to the width direction thereof extending in the X-direction. The daylighting members 71 are coupled when the end portions thereof are inserted into the respective concave insertion sections 77. The present example is described assuming that only the hollow structural bodies 25 of the daylighting members 71 are inserted. Alternatively, the entire end portions of the daylighting members 71, including those of the daylighting sheet 4, may be inserted.

The coupling implement 74 is formed of a material that is transparent to light.

Alternatively, the coupling implement 74 may be formed, for example, of a light-blocking resin material as shown in FIG. 31. The light-blocking coupling implement 74 can prevent glaring light from escaping from the coupling implement 74. The coupling implement 74 is most preferably black, but may be colored in a different color.

The coupling implement 74 of the present example is a separate member from the hollow structural body 25, but may be formed integrally with the hollow structural body 25.

Preferred embodiments of the present invention have been so far described in reference to the attached drawings. The present invention is by no means limited to the embodiments and examples described above. The person skilled in the art could obviously conceive variations and modifications within the scope of the claims. These variations and modifications are encompassed in the technical scope of the claims.

### Lighting-Modulation System

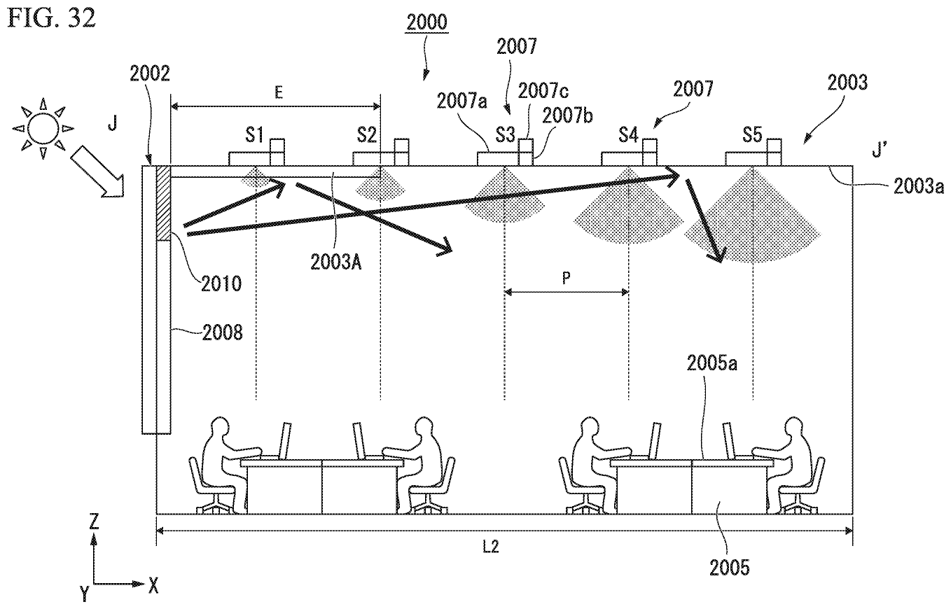

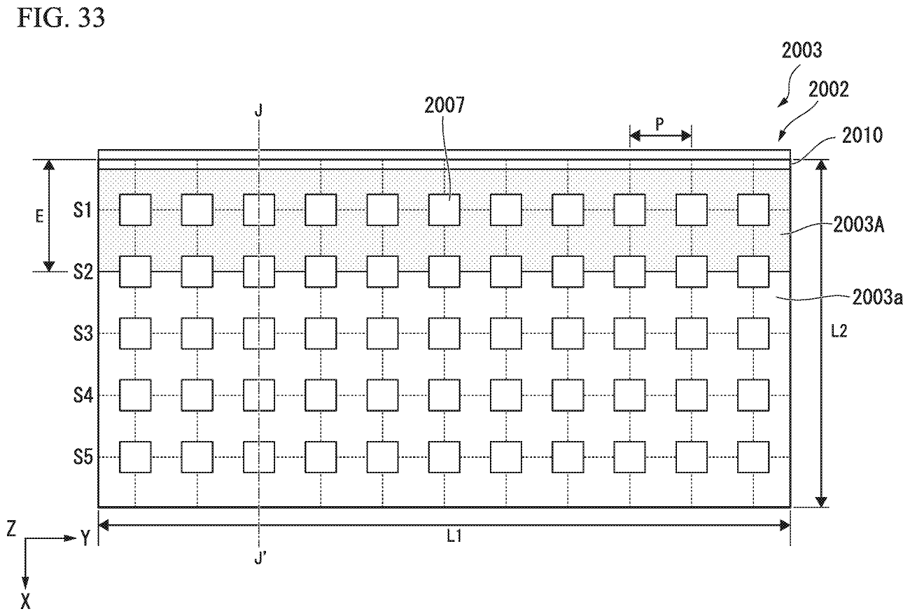

FIG. 32 is a cross-sectional view, taken along line J-J′ in FIG. 33, of a room model 2000 in which a daylighting device and a lighting-modulation system are installed.

FIG. 33 is a plan view of a ceiling of the room model 2000.

In the room model 2000, a room 2003 into which outdoor light is guided has a ceiling 2003a constituted partly by a ceiling material at may have strong light-reflecting properties. Referring to FIGS. 32 and 33, the ceiling 2003a of the room 2003 is provided with a light-reflecting ceiling material 2003A as a ceiling material having such light-reflecting properties. The light-reflecting ceiling material 2003A is for facilitating the guiding of outdoor light from a daylighting device 2010 installed over a window 2002 deep into the interior of the room 2003. The light-reflecting ceiling material 2003A is disposed on a part of the ceiling 2003a close to the window, specifically, on a predetermined part E of the ceiling 2003a (approximately up to 3 meters from the window 2002).

The light-reflecting ceiling material 2003A, as described above, serves to efficiently direct deep into the interior the outdoor light guided indoors through the window 2002 over which the daylighting device 2010 (any of the daylighting devices of the abovementioned embodiments) is installed. The outdoor light guided in the direction of the indoor ceiling 2003a by the daylighting device 2010 is reflected by the light-reflecting ceiling material 2003A, hence changing direction and illuminating a desk top face 2005a of a desk 2005 located deep in the interior. Thus, the light-reflecting ceiling material 2003A has the advantage of lighting up the desk top face 2005a.

The light-reflecting ceiling material 2003A may be either diffuse reflective or specular reflective. Preferably, the light-reflecting ceiling material 2003A has a suitable mix of these properties to achieve both the advantage of lighting up the desk top face 2005a of the desk 2005 located deep in the interior and the advantage of reducing glare which is uncomfortable to the occupant.

Much of the light guided indoors by the daylighting device 2010 travels in the direction of the part of the ceiling that is close to the window 2002. Still, the part of the interior close to the window 2002 often has sufficient lighting. Therefore, the light that strikes the ceiling near the window (part E) can be partially diverted to a deep part of the interior where lighting is poor compared to the part near the window, by additionally using the light-reflecting ceiling material 2003A described here.

The light-reflecting ceiling material 2003A may be manufactured, for example, by embossing convexities and concavities each of approximately a few tens of micrometers on an aluminum or similar metal plate or by vapor-depositing a thin film of aluminum or a similar metal on the surface of a resin substrate having such convexities and concavities formed thereon. Alternatively, the embossed convexities and concavities may be formed on a curved surface with a higher cycle.

Furthermore, the embossed shape formed on the light-reflecting ceiling material 2003A may be changed as appropriate to control light distribution properties thereof and hence resultant indoor distribution. For example, if stripes extending deep into the interior are embossed, the light reflected by the light-reflecting ceiling material 2003A is spread to the left and right of the window 2002 (in the directions that intersect the length of the convexities and concavities). When the window 2002 of the room 2003 is limited in size or orientation, these properties of the light-reflecting ceiling material 2003A may be exploited to diffuse light in the horizontal direction and at the same time to reflect the light deep into the room.

The daylighting device 2010 is used as a part of a lighting-modulation system for the room 2003. The lighting-modulation system includes, for example, the daylighting device 2010, a plurality of room lighting devices 2007, an insolation adjustment device 2008 installed over the window, a control system for these devices, the light-reflecting ceiling material 2003A installed on the ceiling 2003a, and all the other structural members of the room.

The window 2002 of the room 2003 has the daylighting device 2010 installed over an upper portion thereof and the insolation adjustment device 2008 installed over a lower portion thereof. In this example, the insolation adjustment device 2008 is a window shade, which is by no means intended to limit the scope of the invention.

In the room 2003, the room lighting devices 2007 are arranged in a lattice in the left/right direction of the window 2002 (Y-direction) and in the depth direction of the room (X-direction). These room lighting devices 2007, in combination with the daylighting device 2010, constitute an illumination system for the whole room 2003.

Referring to FIGS. 32 and 33 illustrating the office ceiling 2003a, for example, the window 2002 has a length L1 of 18 meters in the left/right direction (Y-direction), and the room 2003 has a length L2 of 9 meters in the depth direction (X-direction). The room lighting devices 2007 in this example are arranged in a lattice with pitches P each of 1.8 meters in the length and depth of the ceiling 2003a (Y-and X-directions). More specifically a total of 50 room lighting devices 2007 is arranged in a lattice of 10 rows (Y-direction) and 5 columns (X-direction).

Each room lighting device 2007 includes an interior lighting fixture 2007a, a brightness detection unit 2007b, and a control unit 2007c. The brightness detection unit 2007b and the control unit 2007c are integrated into the interior lighting fixture 2007a to form a single structural unit.

Each room lighting device 2007 may include two or more interior lighting fixtures 2007a and two or more brightness detection units 2007b, with one brightness detection unit 2007b for each interior lighting fixture 2007a. The brightness detection unit 2007b receives reflection off the face illuminated by the interior lighting fixture 2007a to detect illuminance on that face. In this example, the brightness detection unit 200b detects illuminance on the desk top face 2005a of the desk 2005 located indoors.

The control units 2007c, each for a different one of the room lighting devices 2007, are connected to each other. In each room lighting device 2007, the control unit 2007c, connected to the other control units 2007c, performs feedback control to adjust the light output of an LED lamp in the interior lighting fixture 2007a such that the illuminance on the desk top face 2005a detected by the brightness detection unit 2007b is equal to a predetermined target illuminance L0 (e.g., average illuminance: 750 lx).

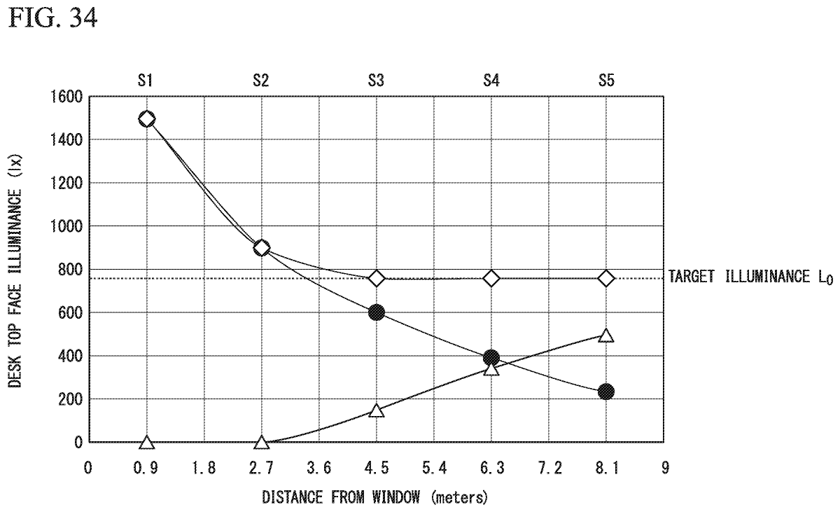

FIG. 34 is a graph representing a relationship between the illuminance produced by the daylighting light (natural light) guided into the interior by the daylighting device and the illuminance produced by the room lighting devices (lighting-modulation system). In FIG. 34, the vertical axis indicates illuminance (lx) on the desk top face, and the horizontal axis indicates distance (meters) from the window. The broken line in the figure represents a target indoor illuminance. Each black circle denotes an illuminance produced by the daylighting device, each white triangle denotes an nee produced by the room lighting devices, and each white diamond denotes a total illuminance.

Referring to FIG. 34, the desk top face illuminance attributable to the daylighting light guided by the daylighting device 2010 is highest at the window, and the daylighting light's effect decreases with increasing distance from the window. This illuminance distribution in the depth direction of the room is caused during the daytime by natural daylight coming through a window into the room in which the daylighting device 2010 is installed. Accordingly, the daylighting device 2010 is used in combination with the room lighting devices 2007 which enhance the indoor illuminance distribution. The room lighting devices 2007, disposed on the indoor ceiling, detect an average illuminance below them by means of the brightness detection units 2007b and light up in a modulated manner such that the desk top face illuminances across the whole room are equal to the predetermined target illuminance L0.

Therefore, columns S1 and S2 are near the window and only dimly light up, whereas columns S3, S4, and S5 light up so as to produce an output that increases with increasing depth into the room. Consequently, the desk top faces across the whole room are lit up by the sum of the illumination by natural daylight and the illumination by the room lighting devices 2007 at a desk top face illuminance of 750 lx, which is regarded as being sufficient for desk work across the whole room (see JIS Z9110, General Rules on Lighting, Recommended Illuminance in Offices).

As described above, light can be delivered deep into the room by using both the daylighting device 2010 and the lighting-modulation system (room lighting devices 2007) together. This can in turn further improve indoor brightness and ensure a sufficient desk top face illuminance for desk work across the whole room, hence providing a more stable, brightly lit environment independently from the season and the weather.

### INDUSTRIAL APPLICABILITY

The present invention, in one aspect thereof, is applicable, for example, to daylighting devices that need to allow for less warping and to come with less weight.

### REFERENCE SIGNS LIST

1, 20, 30, 40, 50, 60, 62, 70, 80 Daylighting Device
4, 18 Daylighting Sheet
4a Light-receiving Face
4b Back Face
5, 5A, 5B, 25, 26, 27, 29, 32, 35, 41, 54, 72 Hollow Structural Body
13a First Face
13b Second Face
11 Daylighting Section
13 Support Base Member (Base Member)
23, 23A, 23B, 23C, 28, 28A, 28B, 28C, 29A, 29B, 31, 33, 34, 36, 53 Rib (Structural Body)
51 First Wall Section (First Plate Section)
52 Second Wall Section (Second Plate Section)
64 Protection Sheet
65 Holding Member
73, 73A, 73B, 78 Coupling Section
74 Coupling Implement (Coupling Section)
92 Support Rod (Coupling Section)
K Hollow Portion
T1, T2 Thickness
W1 Distance

1. A daylighting device comprising:
a daylighting sheet including: a transparent base member; and a plurality of transparent daylighting sections on a first face of the base member; and
at least one hollow structural body composed of a resin provided on a second face of the base member opposite the first face, the at least one hollow structural body including: a transparent, first plate section; a transparent, second plate section opposing the first plate section; a plurality of structural bodies extending in a direction of alignment of the daylighting sections between the first plate section and the second plate section and arranged at prescribed intervals in a direction of extension of the daylighting sections; and at least one hollow portion between the structural bodies.

2. The daylighting device according to claim 1, wherein the structural bodies are transparent.

3. The daylighting device according to claim 1, wherein the at least one hollow portion comprises a plurality of hollow portions, and
the plurality of hollow portions are continuous in the direction of alignment of the daylighting sections.

4. The daylighting device according to claim 1, wherein the structural bodies are subjected to high-visible-light-reflection processing.

5. The daylighting device according to claim 1, wherein at least some of the structural bodies are inclined by a prescribed angle with respect to the second face of the base member.

6. The daylighting device according to claim 1, wherein the structural bodies have a thickness that changes in a direction perpendicular to the second face of the base member.

7. The daylighting device according to claim 1, wherein:
the at least one hollow structural body includes: a first wall section that covers either a light-receiving face of the daylighting sheet on which there is formed a fine structure or a back face of the daylighting sheet opposite the light-receiving face; and a second wall section opposing the first wall section with the structural bodies intervening between the first and second wall sections; and
at least one of the structural bodies, the first wall section, and the second wall section is subjected to micro-scattering processing.

8. The daylighting device according to claim 1, wherein the scattering processing to which at least one of the structural bodies, the first wall section, and the second wall section is subjected is anisotropic in terms of light-diffusion direction in such a manner as to impart high diffusivity in the direction of extension of the daylighting sections.

9. The daylighting device according to claim 1, wherein
the at least one hollow structural body comprises two hollow structural bodies disposed opposing each other; and
the daylighting sheet is disposed between the two hollow structural bodies.

10. The daylighting device according to claim 1, further comprising:
a protection sheet that covers one of surfaces of the daylighting sheet; and
a holding member on at least two of four top, bottom, left, and right sides of the protection sheet, the holding member being capable of simultaneously holding the daylighting sheet and the at least one hollow structural body.

11. The daylighting device according to claim 1, wherein
the at least one hollow structural body comprises a plurality of hollow structural bodies; and
the hollow structural bodies are coupled by a coupling section.

12. The daylighting device according to claim 11, wherein the coupling section is formed integrally with the hollow structural bodies.

13. The daylighting device according to claim 11, wherein the coupling section is light-blocking.
